(19) United States
(12) Patent Application Publication
(10) Pub. No.: US 2007/0075513 A1
(43) Pub. Date: Apr. 5, 2007

(54) Suspension reinforcing kit for a small all terrain vehicle

(75) Inventor: Yvon Caron, St-Cyrille-de-I'lslet (CA)

Correspondence Address: FETHERSTONHAUGH - SMART & BIGGAR, 1000 DE LA GAUCHETIERE WEST, SUITE 3300, MONTREAL, QC, H3B 4W5, CA

(73) Assignee: LES FONTES PNS LTEE

(21) Appl. No.: 11/242,032

(22) Filed: Oct. 4, 2005

(51) Int. Cl. B60G 9/00; B60G 21/055; B60G 11/08

(52) U.S. Cl. 280/124.1; 280/124.107; 280/124.171

(57) ABSTRACT

A suspension reinforcing kit for use with a vehicle having a tow hitch and a suspension having suspension arms to which wheels of the vehicle are mounted. The suspension reinforcing kit has a supporting member for connection to the tow hitch and a reinforcing arrangement including a resilient member for mounting to the supporting member. The reinforcing arrangement is designed to engage at least one of the suspension arms of the vehicle. In use, the resilient member will tend to resist a compression movement of the at least one suspension arm.

### FIELD OF THE INVENTION

The invention relates to a kit used to reinforce the suspension of a vehicle, specifically a small, all terrain vehicle (hereinafter “ATV”).

### BACKGROUND OF THE INVENTION

Small all terrain vehicles that are of the type intended to carry one or two passengers are well known. Such vehicles have a structure that is somewhat analogous to a motorcycle. Specifically, the vehicle has a seat for the driver located behind a pair of handle bars that are used to steer the vehicle.

Such small all terrain vehicles are very popular in mountainous and rugged terrain regions since they are fairly small and thus highly maneuverable and can provide access to locations that otherwise would be difficult to reach with other transportation means.

In designing such vehicles the manufacturers will attempt to provide performance goals according to the typical uses for which the vehicle is intended. The suspension of the vehicle is one specific area where conflicting requirements often lead to compromises that may render the vehicle unsuitable for certain tasks. On one hand, it may be desired to design the suspension to be supple to provide rider comfort, but on the other hand a soft suspension is unsuitable for utilitarian tasks such as load hauling or trailer towing.

Against this background, there is a clear need in the industry to provide devices that can be used to change the characteristics of the suspension of a vehicle such as to allow adapt it for specific applications.

### SUMMARY OF THE INVENTION

According to a first broad aspect the invention provides a suspension reinforcing kit for use with a vehicle having a tow hitch and a suspension having suspension arms to which wheels of the vehicle are mounted. The suspension reinforcing kit has a supporting member for connection to the tow hitch and a reinforcing arrangement including a resilient member for mounting to the supporting member. The reinforcing arrangement is designed to engage at least one of the suspension arms of the vehicle. In use, the resilient member will tend to resist a compression movement of the at least one suspension arm.

In a non-limiting example of implementation, the tow hitch is a receptacle style tow hitch. The supporting member has a projection fitting the receptacle of the tow hitch. The supporting member is releasably engaged in the tow hitch such that it can be easily removed when the reinforcing is not required. The supporting member is provided with a towing connection to allow the vehicle to tow a trailer when the supporting member occupies the tow hitch. The towing connection can take various forms. One possible option is to design the towing connection such as to replicate the receptacle style tow hitch.

The reinforcing arrangement is pivotally mounted to the supporting member. The pivotal movement occurs along a pivot axis that is generally parallel to the pivotal movement of the suspension arms.

In a second broad aspect, the invention provides a suspension reinforcing kit for use with an all terrain vehicle. The all terrain vehicle has a tow hitch extending along a longitudinal axis of the vehicle and a suspension including first and second suspension arms to which respective wheels of the vehicle are mounted. The first and second suspension arms are located on opposite sides of the longitudinal axis. The suspension reinforcing kit includes a supporting member for connection to the tow hitch and a leaf spring for pivotal mounting to the supporting member such as to extend generally transversally to the longitudinal axis of the vehicle. The leaf spring has opposite end portions for engaging respectively the first and second suspension arms, whereby the first and second suspension arms transfer loads to the leaf spring by causing the leaf spring to resiliently yield when the suspension of the vehicle is downwardly compressed.

In a third broad aspect the invention provides a supporting member for a suspension reinforcing kit, the suspension reinforcing kit intended to be used with an all terrain vehicle having a suspension and a receptacle style tow hitch. The supporting member includes a projection capable of being releasably mounted in a receptacle of the tow hitch. The supporting member also including a pivotal mounting arrangement for pivotally supporting a leaf spring capable of interacting with suspension arms of the vehicle such that during use of the vehicle the suspension of the vehicle transfers loads to the leaf spring.

In a fourth broad aspect the invention provides a suspension reinforcing kit for use with a vehicle having a suspension including suspension arms to which wheels of the vehicle are mounted. The suspension reinforcing kit has a supporting member for connection to the vehicle and a reinforcing arrangement including a resilient member. The reinforcing arrangement pivotally mounts to the supporting member and is capable of engaging at least one of the suspension arms, the resilient member tending to resist a compression movement of the at least one suspension arm.

### BRIEF DESCRIPTION OF THE DRAWINGS

A detailed description of examples of implementation of the present invention is provided hereinbelow with reference to the following drawings, in which:

FIG. 1 is a perspective view from the rear of a small all terrain vehicle showing a non-limiting example of a reinforcing kit according to the invention, mounted to the tow hitch of the vehicle;

FIG. 2 is another perspective view of the rear of an all terrain vehicle showing the placement of suspension arm connectors;

FIGS. 3-8 are schematical views of suspension reinforcing kits according to further variants;

FIGS. 9-17 are exploded views of variants of the suspension reinforcing kit.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

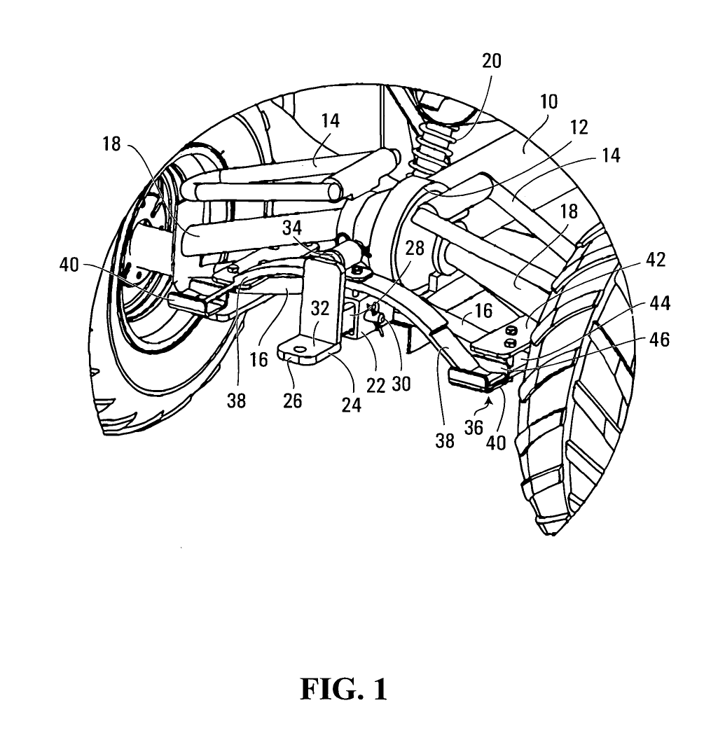

FIG. 1 shows the rear of a small all terrain vehicle that has a chassis 10 including a differential 12. The all terrain vehicle has an independent suspension. The independent suspension includes suspension arms holding each rear wheel. Specifically, each rear wheel includes an upper suspension arm 14 and a lower suspension arm 16. Between each pair of suspension arms 14, 16 is located a drive shaft 18 that drives the respective wheel. The suspension of the all terrain vehicle includes a plurality of spring/shock absorber combinations 20, associated with respective wheels. One such combination 20 is shown in FIG. 1 and it includes a coil spring receiving a shock absorber. The combination 20 attaches to the differential 12.

The chassis 12 of the vehicle includes a receptacle style tow hitch 22 that is intended to connect to a trailer that can be towed by the vehicle. The tow hitch includes a receptacle of generally rectangular cross-sectional shape intended for receiving a mating projection at the trailer side.

In a non-limiting example of implementation, the invention uses the tow hitch for mounting of the suspension reinforcing kit. More particularly, the suspension reinforcing kit includes a supporting member 24 that installs in the tow hitch 22. The supporting member 24 has an L-shaped plate 26 on the back of which is welded a projection 28 that matingly fits the receptacle of the tow hitch 22. A locking pin 30 or any other suitable fastener is used to secure the supporting member 24 in place and prevent unwanted removal from the tow hitch 22. The horizontal portion 32 of the L-shaped plate 26 is provided with an aperture that can be used as a towing connection, thus allowing the vehicle to tow a trailer when the supporting member 24 is mounted in the tow hitch 22. In a possible variant not shown in the drawings, a receptacle style tow hitch can be replicated on the supporting member 24 to prevent any loss of functionality when the supporting member 24 is connected t the tow hitch 22. The tow hitch replicator can be in the shape of a hollow rectangular tubing that is welded to the L-shaped plate 24 in such a way as to open to the back of the vehicle.

The upper end of the L-shaped plate 24 holds a horizontally projecting pivot 34. The pivot 34 is in the form a cylindrical projection that receives a reinforcing arrangement 36. The reinforcing arrangement 36 includes a leaf spring 38 that extends generally across the longitudinal axis of the vehicle, and a pair of suspension arm connectors 40. Each suspension arm connector 40 attaches to a respective lower suspension arm 16 and moves in unison as the suspension arm 16 travels up and down. The suspension arm connector 40 includes a pair of horizontal plates 42, 44 that straddle the suspension arm 16 and are connected to one another by bolts. An extension 46 projects rearwardly from the lower plate 44. The extension 46 slidingly receives the respective extremity of the leaf spring 38.

The leaf spring 38 is provided at its top portion with a hollow cylindrical body 35 that receives the pivot 34. A locking pin 37 prevents unwanted removal of the leaf spring 38 from the pivot 34. This arrangement allows the leaf spring 34 that extends transversally to the longitudinal axis of the vehicle to pivot with relation to the supporting member 24, about an axis that is parallel (or coincides with) the longitudinal axis of the vehicle. The pivot axis is also parallel to the axes about which the suspension arms 14, 16 of the vehicle move when the suspension is compressed or released.

In use, when the suspension of the vehicle is compressed down, such as to cause the rear wheels to move up with relation to the driver seat, the suspension arm connectors 42 transfer loads on the leaf spring 38 by causing the leaf spring to resiliently yield. This allows the suspension of the vehicle to take-up higher loads than otherwise possible. As the leaf spring 38 is compressed, its extremities slide outwardly in the respective extensions 46. Conversely, when the rear wheels move down and the leaf spring 38 is relaxed, the extremities of the leaf spring 38 slide inwardly in the extensions 46.

The pivotal leaf spring mounting arrangement is effective when only one wheel rises, which is the case when the vehicle passes over a bump deflecting one wheel only. In such case, the pivotal connection 34 will allow the entire leaf spring 38 to yield, not only the half associated with the deflecting wheel. By allowing both halves of the leaf spring 38 to yield when a single wheel rises, in effect doubles the suspension travel before the leaf spring 38 becomes exceeding stiff, by comparison to a non-pivotal arrangement where only half of the leaf spring 38 yields when a single wheel rises.

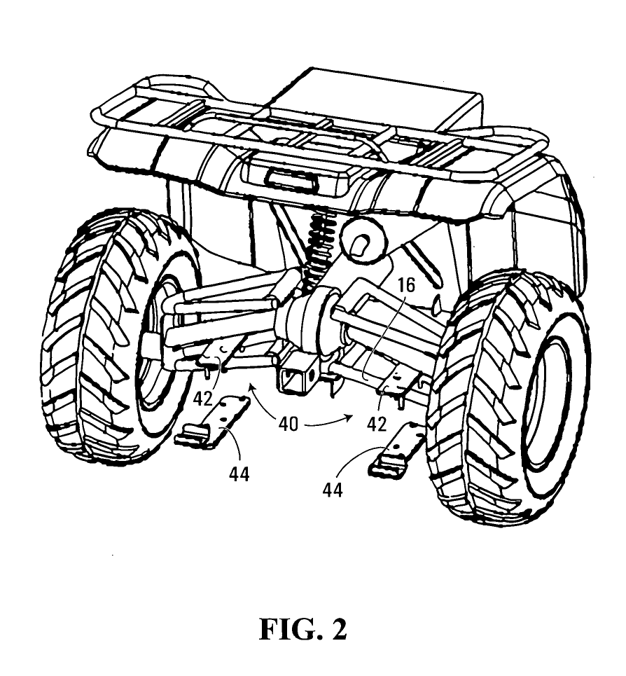

The suspension reinforcing kit is relatively simple to install and remove from the vehicle. With reference to FIG. 2, the first operation in order to install the suspension reinforcing kit is to mount the suspension arm connectors 40. The plates 42 and 44 are placed on the respective lower suspension arms 16 and the tightened in place by bolts. The leaf spring 38 is placed on the pivot 34 by inserting the pivot in the hollow cylindrical body 35 mounted on the leaf spring 38. A locking pin 37 is inserted through the pivot 34 so as to prevent unwanted removal of the leaf spring 38. The supporting member 34 is then inserted in the tow hitch 22 by sliding the projection 28 in the receptacle of the tow hitch. The locking pin 30 is put in place to prevent removal of the supporting member 34.

When the suspension reinforcing kit is no longer required it can be removed easily from the vehicle. To this effect, the locking pin 30 is removed to free the support member 34 which can be pulled away from the tow hitch 22. The support member 34 and the leaf spring 38 can then be put aside. It is not necessary to remove the suspension arm connectors 40 since they do not alter in any way the normal operation of the suspension. Thus the suspension arm connectors 40 can permanently remain in place on the vehicle.

The examples described earlier show the suspension reinforcing kit mounted on the rear suspension arms. It should be appreciated that the suspension reinforcing kit can also be mounted at the front of the vehicle that sometimes is also provided with a tow hitch. If desired a suspension reinforcing kit can be placed at the rear and also at the front to provide an increased reinforcing effect.

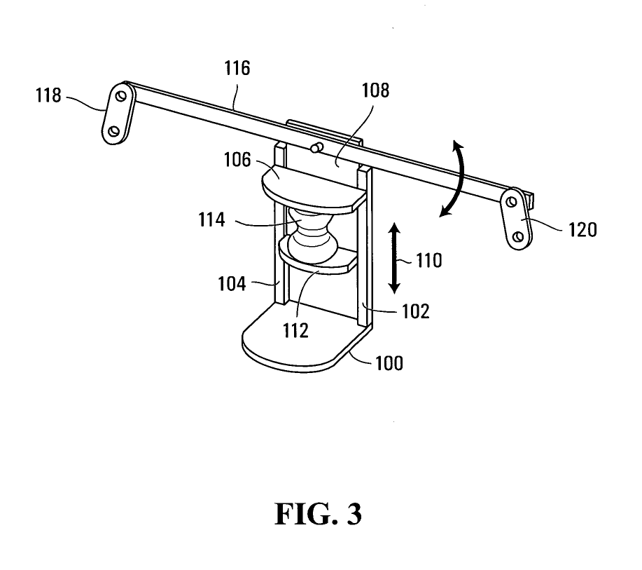

FIG. 3 illustrates the principle of operation of a variant of the suspension reinforcing kit.

The kit includes a supporting member 100 that mounts to the vehicle in the same way as the supporting member 24. The supporting member 100 is in the form of an L-shaped plate that has a main horizontal portion including two generally parallel protruding side edges 102, 104. An abutment plate 106 extends transversally to the horizontal portion and it is welded to respective side edges 102, 104. A slider plate 108 is mounted between the edges 102, 104. The slider plate 108 is capable to slide up and down, as shown by the arrow 110, between the side edges 102, 104. The slider plate 108 is L-shaped and has a short horizontal portion 112 that is generally parallel to the abutment plate 106. When the slider plate 108 moves up or down the horizontal portion 112 remains generally parallel to the abutment plate 106.

A resilient member 114 is placed between the horizontal portion 112 and the abutment plate 106. The resilient member can be in the form of a coil spring or an air spring and it is designed to resiliently yield when the slider plate 108 moves up. It will be appreciated that as the slider plate 108 moves up, the resilient member 114 is compressed and tends to resist the upward movement.

A horizontal bar 116 is pivotally mounted to the upper end portion of the slider plate 108. The pivotal movement is effected about an axis which extends generally along the longitudinal axis of the vehicle. Short links 118, 120 are provided to connect to the suspension arms of the vehicle.

When the system is at rest, the resilient member 114 tends to separate the horizontal portion 112 from the abutment plate 106. This has the effect of driving down the slider plate 108. The slider plate 108 can move down up to a point where the bar 116 abuts against the top portions of the side edges 102, 104. The drawing of FIG. 3 shows the bar 116 in this abutting position.

In use, when the suspension of the vehicle is compressed down such that both rear wheels move up with relation to the seat of the driver, the short links 118 and 120 uniformly cause the bar 116 to rise. In turn, this rising movement causes the slider plate 108 to move up and compress the resilient member 114, taking up some of the loads exerted on the suspension of the vehicle. In the case when an asymmetric movement is encountered such as when one end of the bar 116 rises while the other end is not rising, the slider plate 108 is still caused to move up by virtue of the fact that the bar 116 abuts against the upper portions of the side edges 102, 104. Specifically, when the end portion of the bar 116 that supports the short link 120 goes up, the bar abuts on the top portion of the side edge 104 and thus pulls the slider plate 108, causing the resilient member 114 to compress.

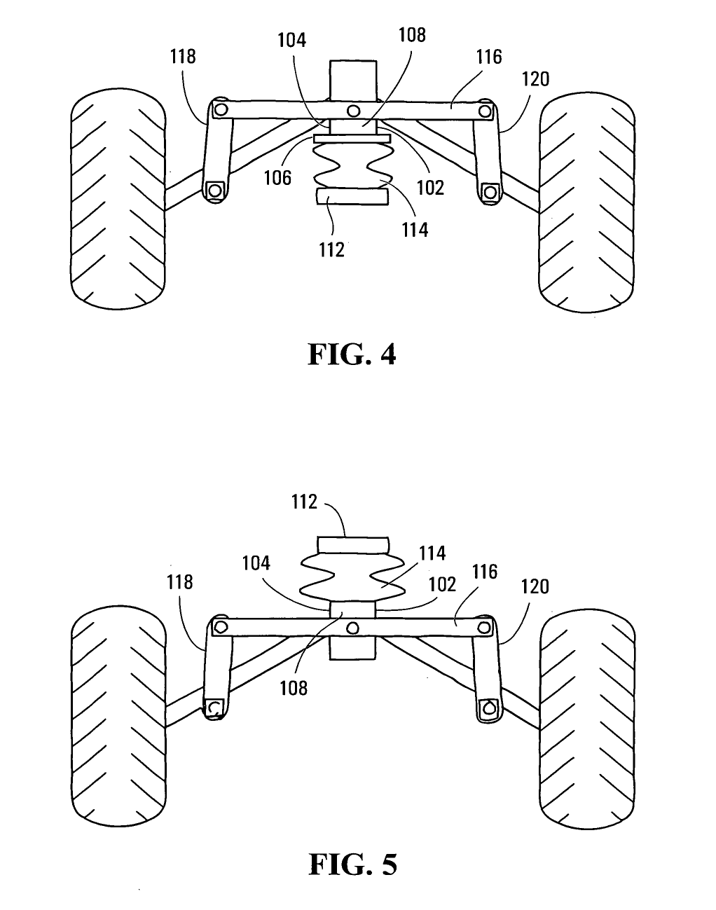

FIG. 4, shows schematically the arrangement of FIG. 3, mounted on a vehicle. The reader will appreciate that a number of details have not been shown for the purposes of clarity. FIG. 5 shows a variant of the arrangement of FIG. 4. In this variant, the position of the resilient member 114 has changed. This modification changes to some extent the way the system works. More particularly, when the suspension is compressed such as to cause the bar 116 to move up and abut the end portions of the side edges 102, 104 the entire suspension of the vehicle is blocked and cannot compress any further. An asymmetric compression is still possible (one wheel moves up and one goes down) as discussed in connection with FIG. 4, against the resilient member 114.

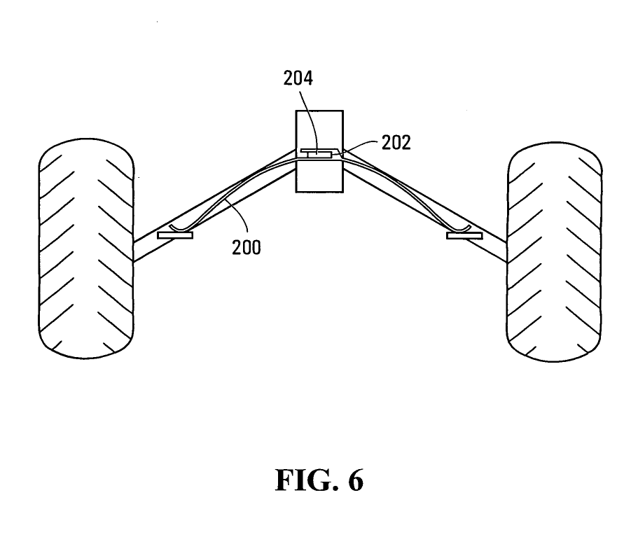

FIG. 6 shows yet another variant that is similar to the arrangement illustrated in FIG. 1. Specifically a leaf spring is used but this time the leaf spring is mounted to the vehicle with a rigid connection and not a pivotal connection. In this example, the leaf spring 200 defines a clamp 202 that engages a rigid tongue 204 that connects to the vehicle chassis.

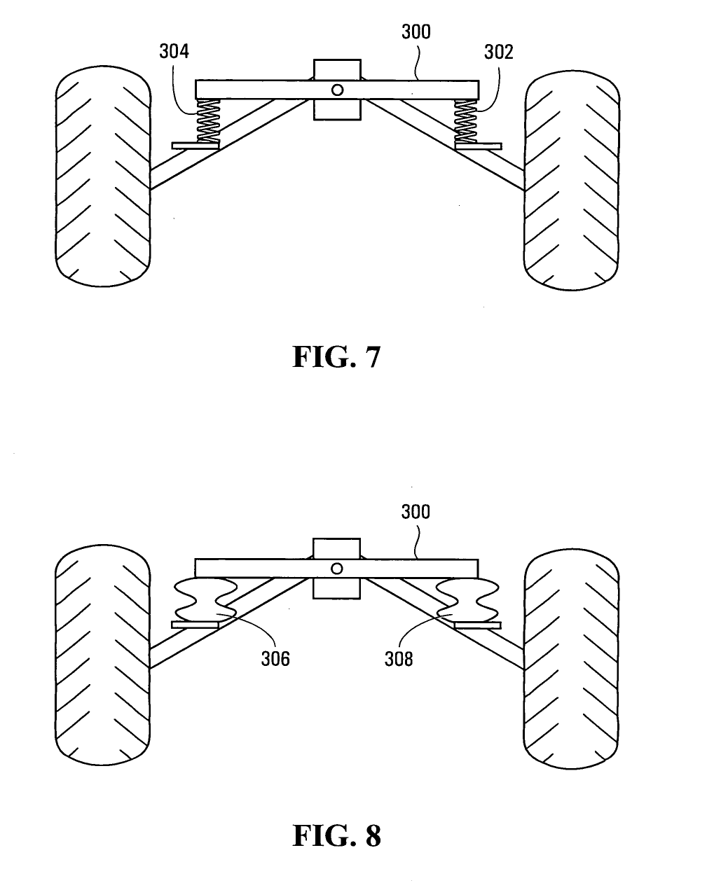

FIG. 7 illustrates yet another variant. A rigid bar 300 is pivotally mounted to the chassis of the vehicle (such as via a support member carried on the tow hitch) and engages the suspension arms of the vehicle via coil springs 302, 304. FIG. 8 is another example of such design where the coil springs 302, 304 are replaced by air springs 306, 308.

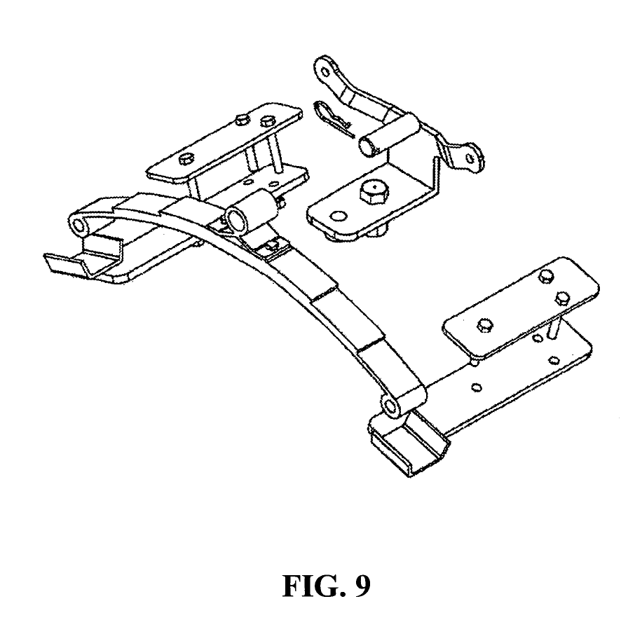

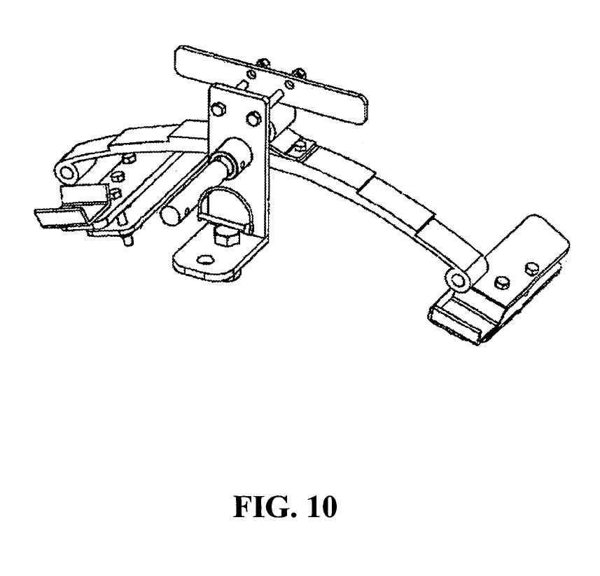

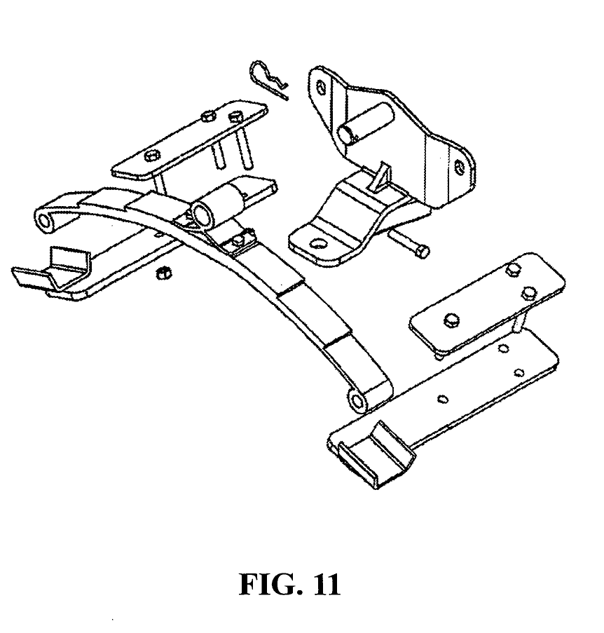

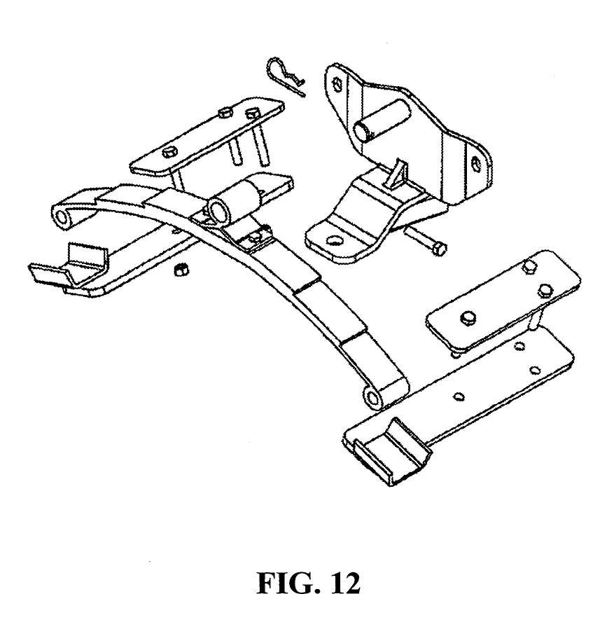

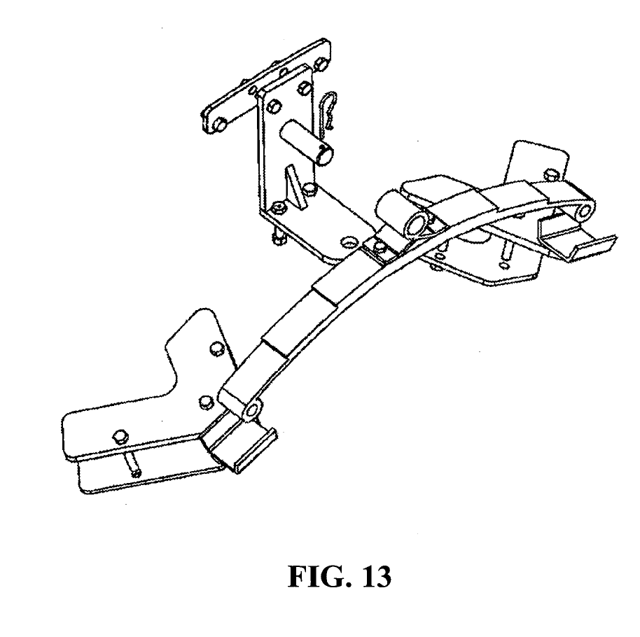

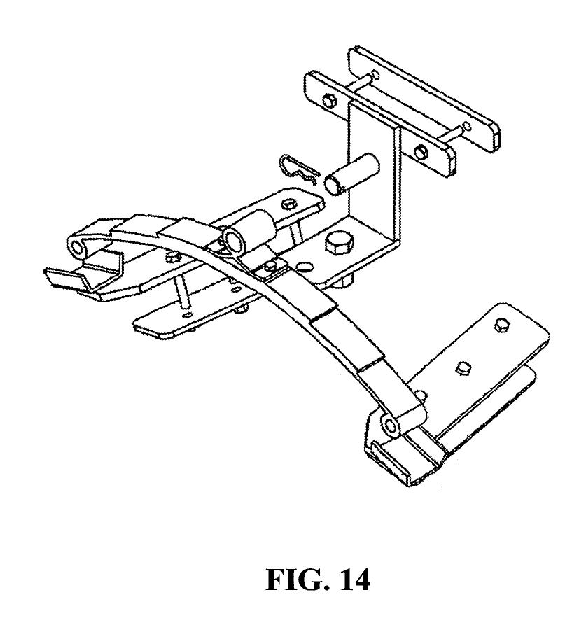

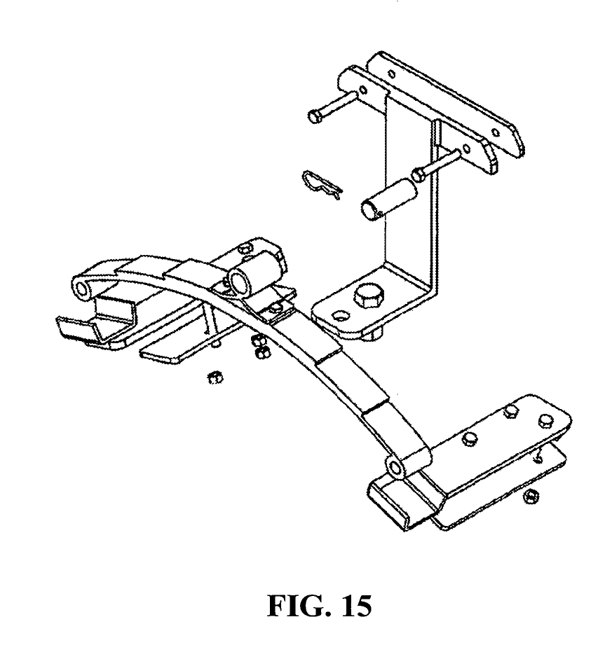

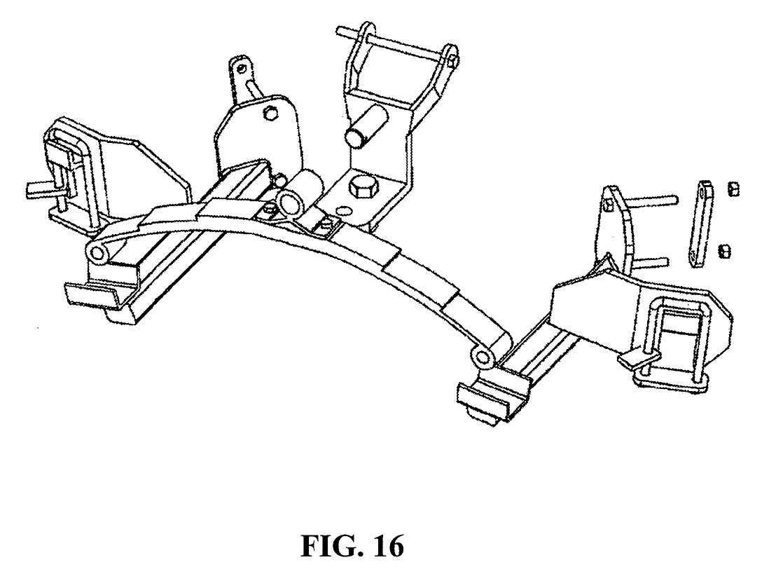

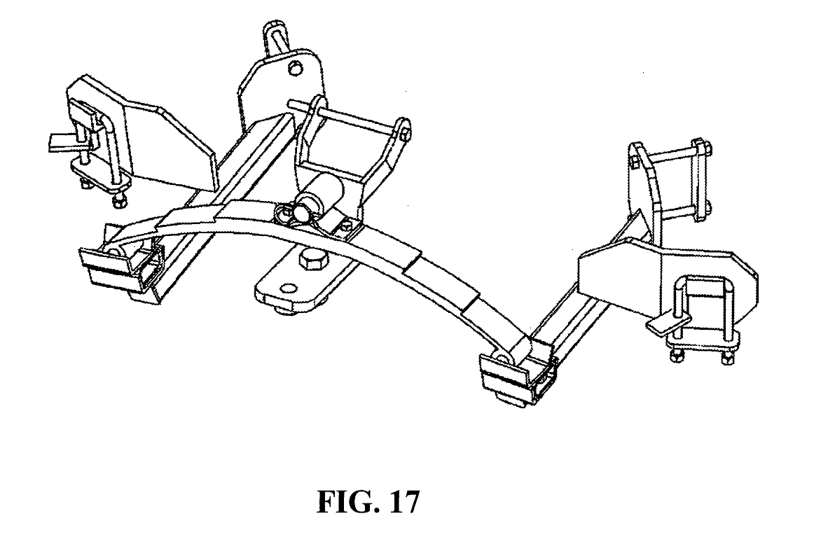

FIGS. 9 to 17 are exploded views of others examples of implementation. The intent of those views is to illustrate the variety of possible support members that can be provided to fit different tow hitch types.

Although various embodiments have been illustrated, this was for the purpose of describing, but not limiting, the invention. Various modifications will become apparent to those skilled in the art and are within the scope of this invention, which is defined more particularly by the attached claims.

1. A suspension reinforcing kit for use with a vehicle, having:
a) a tow hitch;
b) a suspension including suspension arms to which wheels of the vehicle are mounted;
c) said suspension reinforcing kit comprising:
i) a supporting member for connection to the tow hitch;
ii) a reinforcing arrangement including a resilient member for mounting to said supporting member and for engaging at least one of the suspension arms, the resilient member tending to resist a compression movement of the at least one suspension arm.

2. A suspension reinforcing kit as defined in claim 1, wherein said supporting member is capable of being releasably connected to the tow hitch.

3. A suspension reinforcing kit as defined in claim 2, wherein the tow hitch is a receptacle style tow hitch, having a receptacle.

4. A suspension reinforcing kit as defined in claim 3, wherein said supporting member includes a projection for engagement in the receptacle of the tow hitch.

5. A suspension reinforcing kit as defined in claim 4, wherein said projection has a rectangular cross-sectional shape.

6. A suspension reinforcing kit as defined in claim 5, including a locking device to prevent unwanted removal of said supporting member from the tow hitch.

7. A suspension reinforcing kit as defined in claim 2, including a towing connection on said supporting member.

8. A suspension reinforcing kit as defined in claim 2, wherein said reinforcing arrangement is pivotally mounted to said supporting member.

9. A suspension reinforcing kit as defined in claim 8, wherein said reinforcing arrangement is releasably mounted to said supporting member.

10. A suspension reinforcing kit as defined in claim 9, wherein including a locking element to prevent unwanted removal of said reinforcing arrangement from said supporting member.

11. A suspension reinforcing kit as defined in claim 8, wherein said reinforcing arrangement is pivotally mounted to said supporting member along an axis that is generally parallel to an axis of pivotal movement of the at least one suspension arm.

12. A suspension reinforcing kit as defined in claim 9, wherein said resilient member includes a leaf spring.

13. A suspension reinforcing kit as defined in claim 9, wherein said resilient member includes a coil spring.

14. A suspension reinforcing kit as defined in claim 9, wherein said resilient member includes an air spring.

15. A suspension reinforcing kit as defined in claim 2, wherein said reinforcing arrangement includes a suspension arm connector for mounting to the at least one suspension arm.

16. A suspension reinforcing kit as defined in claim 15, wherein said suspension arm connector includes a portion for slidingly engaging said resilient member.

17. A suspension reinforcing kit for use with an all terrain vehicle having a longitudinal axis, the vehicle having:
a) a tow hitch;
b) an independent suspension including first and second suspension arms to which respective wheels of the vehicle are mounted, the first and second suspension arms being located on opposite sides of the longitudinal axis;
c) said suspension reinforcing kit comprising:
i) a supporting member for connection to the tow hitch;
ii) a leaf spring for pivotal mounting to said supporting member such as to extend generally transversally to the longitudinal axis, said leaf spring having opposite end portions for engaging respectively the first and second suspension arms, the first and second suspension arms transferring loads to said leaf spring by causing said leaf spring to resiliently yield when the suspension of the vehicle is downwardly compressed.

18. A supporting member for a suspension reinforcing kit, the suspension reinforcing kit intended to be used with an all terrain vehicle having a suspension and a receptacle style tow hitch, said supporting member comprising;
a) a projection for releasable mounting in a receptacle of the tow hitch;
b) a pivotal mounting arrangement for pivotally supporting a leaf spring capable of interacting with suspension arms of the vehicle such that during use of the vehicle the suspension of the vehicle transfers loads to the leaf spring.

19. A suspension reinforcing kit for use with a vehicle, having:
a) a suspension including suspension arms to which wheels of the vehicle are mounted;
b) said suspension reinforcing kit comprising:
i) a supporting member for connection to the vehicle;
ii) a reinforcing arrangement including a resilient member, said reinforcing arrangement pivotally mounted to said supporting member and capable of engaging at least one of the suspension arms, the resilient member tending to resist a compression movement of the at least one suspension arm.

20. A suspension reinforcing kit as defined in claim 19, wherein said supporting member is capable of being releasably connected to a tow hitch of the vehicle.

21. A suspension reinforcing kit as defined in claim 20, wherein the tow hitch is a receptacle style tow hitch, having a receptacle.

22. A suspension reinforcing kit as defined in claim 21, wherein said supporting member includes a projection for engagement in the receptacle of the tow hitch.

23. A suspension reinforcing kit as defined in claim 22, wherein said projection has a rectangular cross-sectional shape.

24. A suspension reinforcing kit as defined in claim 21, including a locking device to prevent unwanted removal of said supporting member from the tow hitch.

25. A suspension reinforcing kit as defined in claim 24, including a towing connection on said supporting member.

26. A suspension reinforcing kit as defined in claim 21, wherein said reinforcing arrangement is releasably mounted to said supporting member.

27. A suspension reinforcing kit as defined in claim 26, wherein including a locking element to prevent unwanted removal of said reinforcing arrangement from said supporting member.

28. A suspension reinforcing kit as defined in claim 21, wherein said reinforcing arrangement is pivotally mounted to said supporting member along an axis that is generally parallel to a pivot axis of the at least one suspension arm.

29. A suspension reinforcing kit as defined in claim 28, wherein said resilient member includes a leaf spring.

30. A suspension reinforcing kit as defined in claim 28, wherein said resilient member includes a coil spring.

31. A suspension reinforcing kit as defined in claim 28, wherein said resilient member includes an air spring.
